(19) United States
(12) Patent Application Publication
(10) Pub. No.: US 2011/0297903 A1
(43) Pub. Date: Dec. 8, 2011

(54) WINCH ASSEMBLY

(75) Inventor: Joseph August Hraban, Two Harbors, MN (US)

(73) Assignee: Sure-Fab LLC, Two Harbors, MN (US)

(21) Appl. No.: 13/152,852

(22) Filed: Jun. 3, 2011

Related U.S. Application Data
(60) Provisional application No. 61/350,996, filed on Jun. 3, 2010.

(51) Int. Cl. B66D 1/00; B66C 1/10; B66D 1/60

(52) U.S. Cl. 254/323; 294/219

(57) ABSTRACT

A winch assembly includes a winch and a hitch assembly coupled to the winch. The hitch assembly includes an attachment bar, a spear receiving portion and a spear configured to be seated in the spear receiving portion. A cable is coupled to the winch and the spear for extending and/or retracting the spear relative to the spear receiving portion.

### CROSS-REFERENCE TO RELATED APPLICATION

This application claims priority under 35 U.S.C. §119(e) to U.S. Provisional Patent Application Ser. No. 61/350,996 filed on Jun. 3, 2010, and incorporated herein by reference.

### BACKGROUND

Winch assemblies are known for attachment to vehicles and the like for transportation of objects. In general, the winch assemblies include a hand powered or electrically powered winch that extends or retracts a cable. The cable is hooked to the object and is extended or retracted relative to the winch.

### SUMMARY

A winch assembly for coupling to a tow hitch of a vehicle includes a winch and a hitch assembly coupled to the winch. The hitch assembly includes an attachment bar, a spear receiving portion including an inner arcuate surface and a spear including an outer arcuate surface configured to register with the inner arcuate surface. A cable is coupled to the winch and the spear such that the spear can be selectively extended and/or retracted with respect to the winch.

### BRIEF DESCRIPTION OF THE DRAWINGS

The accompanying drawings are included to provide a further understanding of concepts presented herein and are incorporated in and constitute a part of this specification. The drawings illustrate embodiments and together with the description serve to explain principles of the concepts. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of an exemplary winch assembly with a spear of a hitch assembly in a retracted position.

FIG. 2 is a perspective view of the winch assembly illustrated in FIG. 1 with the spear of the hitch assembly in a partially extended position.

FIG. 3 is a top view of the hitch assembly illustrated in FIG. 1.

FIG. 4 is a partially exploded side view of the hitch assembly illustrated in FIG. 1.

FIG. 5 is a side view of a cable.

### DETAILED DESCRIPTION

In the following Detailed Description, reference is made to the accompanying drawings, which form a part hereof, and in which is shown by way of illustration specific embodiments in which the concepts presented herein may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

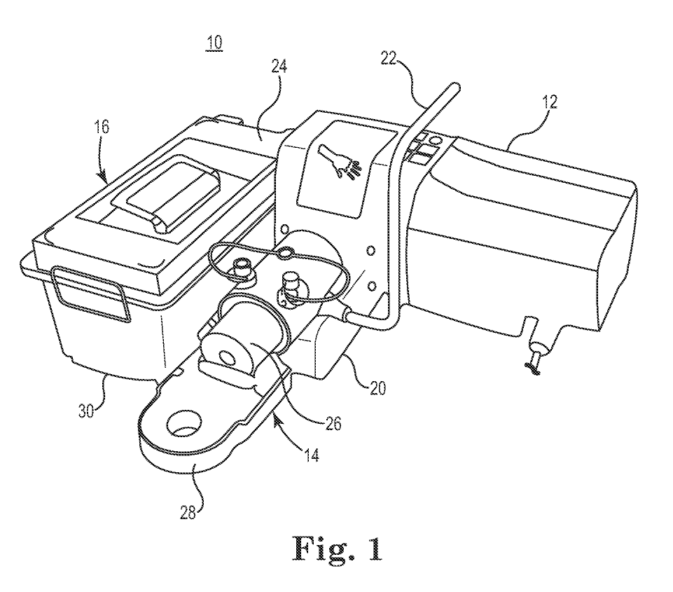

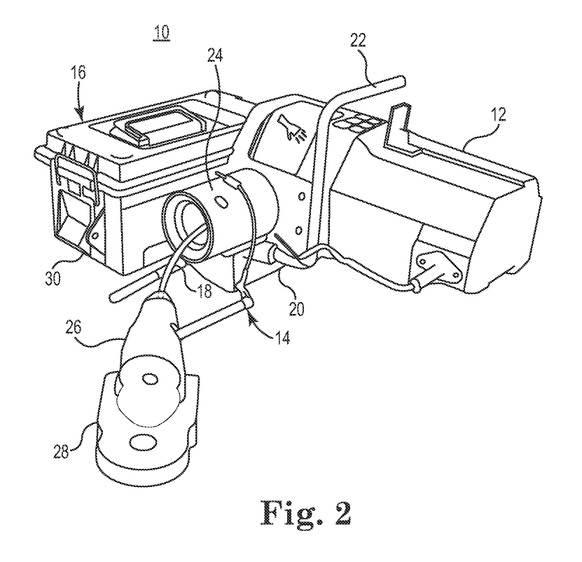

FIGS. 1 and 2 illustrate a powered winch assembly 10 including a powered winch 12, a hitch assembly 14 and an optional accessory 16. In particular, FIG. 1 illustrates the hitch assembly 14 in a retracted position, whereas FIG. 2 illustrates the hitch assembly in a partially extended position. Winch assembly 10 is adapted to be secured to a vehicle. As used herein, a vehicle includes any motorized vehicle such as a car, truck, all-terrain vehicle (ATV), wheeled work machine, tractor, yard tractor and the like. The winch 12, in one embodiment, is a Superwinch® brand powered winch (e.g., Models S4000 and S5000) available from Superwinch, Inc. of Putnam, Conn. In other embodiments, winch 12 can be a hand crank that is manually operated. Regardless of a particular configuration for winch 12, the winch 12 maintains a cable 18 (FIG. 2) and a reel (not shown, generally positioned within an enclosure of the powered winch 12) for extending and/or retracting a portion of hitch assembly 14, as will be discussed below. Hitch assembly 14 is adapted to be coupled with the winch 12 such that the hitch assembly 14 can be attached to a trailer hitch of a vehicle as well as an object to be transported relative to the vehicle such as a tank, wagon, cart and/or auger. Additionally, hitch assembly 14 can be coupled to the optional accessory 16. In the embodiment illustrated, optional accessory 16 is a tool box, although other accessories can also be utilized.

Hitch assembly 14 includes a vehicle attachment bar 20, a handle 22, a spear receiving portion 24, a spear 26, a hitch plate 28 and an accessory mounting portion 30. Winch 12 is directly mounted to attachment bar 20, whereas accessory 16 is coupled to the attachment bar 20 through accessory mounting portion 30. Handle 22 allows a user to grasp, carry and secure hitch assembly 14 to the vehicle. Adequate clearance is provided for handle 22 to accommodate winch 12. Spear receiving portion 24 is mounted to attachment bar 20 and configured to receive spear 26, which can be extended and/or retracted relative to winch 12. Hitch plate 28 is mounted to spear 26 and is configured to be coupled to an object. In the retracted position of FIG. 1, spear 26 is completely registered within spear receiving portion 24, whereas in FIG. 2, cable 18 has been extended and spear 26 is separated from spear receiving portion 24.

Once the hitch plate 28 is attached to the desired object, winch 12 can be operated such that the object is brought proximate the rear of the vehicle or, as the case may be, refracted away from the vehicle. For example, a user can extend hitch plate 28 away from winch 12 (for example as shown in the partially extended position of FIG. 2) to the object such that the object is coupled thereto. Once the object is coupled to hitch plate 28, winch 12 is operated such that spear 26 registers within spear receiving portion 24, as illustrated in the retracted position of FIG. 1. The spear 26 can then be secured in place within the spear receiving portion 24 such that the vehicle can be safely operated to secure and/or transport the object to a desired location.

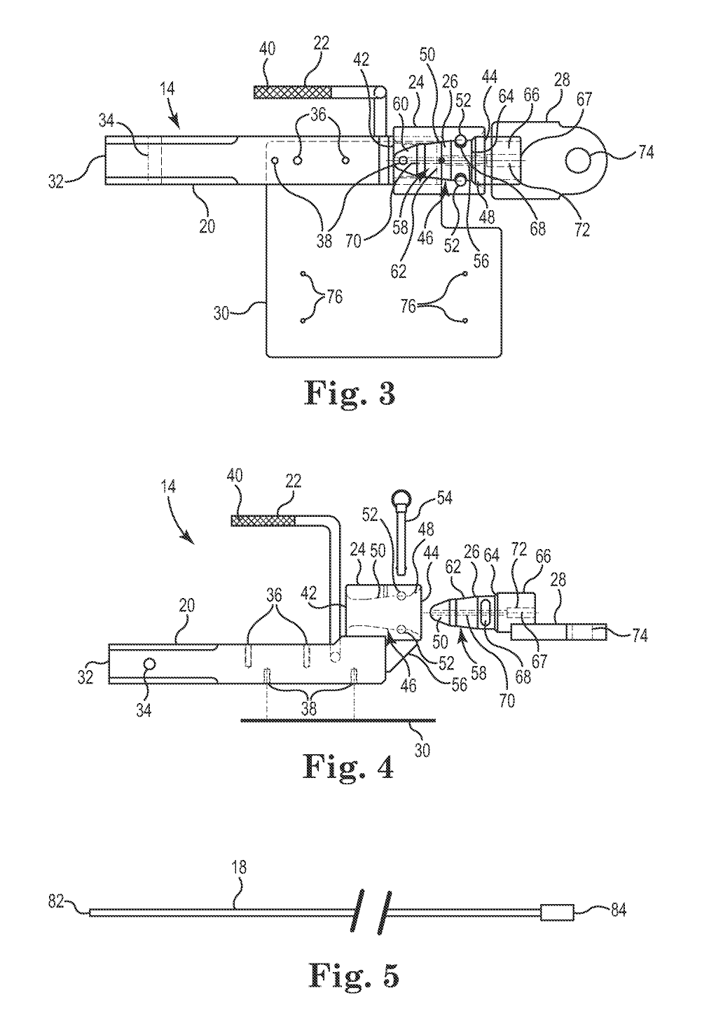

With further reference to FIGS. 3 and 4, vehicle attachment bar 20, in one embodiment, is a generally rectangular elongated bar configured to be positioned within a hitch receiving portion of a vehicle. For example, vehicle attachment bar 20 includes an end 32 configured to be inserted into the hitch receiving portion. An aperture 34 is provided within vehicle attachment bar 20 to receive a pin so as to secure the vehicle attachment bar 20 to the vehicle. Vehicle attachment bar 20 further includes a first set of fastener receiving portions 36 configured to receive fasteners in order to mount winch 12 to the vehicle attachment bar 20. A second set of fastener receiving portions 38 is provided within vehicle attachment bar 20, configured to receive fasteners in order to mount accessory mounting portion 30 to the vehicle attachment bar 20.

Handle 22 extends from the vehicle attachment bar 20 and, in the embodiment illustrated, is generally ‘L’ shaped and provides clearance relative to vehicle attachment bar 20 so that winch 12 can be mounted using the first set of fastener receiving portions 36 such that a user can grasp handle 22 without interference from the winch 12. Handle 22 can further include a gripping portion 40, which can be formed by knurling handle 22. By grasping handle 22, a user can stabilize hitch assembly 14 so attachment bar 20 can be inserted into the hitch receiving portion of the vehicle.

Spear receiving portion 24 is generally tubular in shape, having a generally cylindrical outer surface. Spear receiving portion 24 further includes a first open end 42 (facing end 32 of attachment bar 20), a second open end 44 (facing spear 26) and an inner arcuate surface 46. Arcuate surface 46 includes a recessed bevel 48 and a tapered portion 50 configured to cooperate with spear 26 (i.e., shaped to receive and secure spear 26 therein). Spear receiving portion 24 further includes a set of apertures 52 configured to receive corresponding locking pins 54 so as to secure spear 26 within the spear receiving portion 24. In one embodiment, a gusset 56 is used to support spear receiving portion 24 on attachment bar 20. In one example, spear receiving portion 24 is welded to a top of attachment bar 20 so as to be offset therefrom.

Spear 26 is generally conical in shape and registers (or seats) into the spear receiving portion 24 such that, once registered, movement between spear 26 and spear receiving portion 24 is limited. Additionally, the spear 26, once registered in the spear receiving portion 24, can be rotated relative to spear receiving portion 24 so as to accommodate locking pins 54 inserted through the apertures 52 in receiving portion 24. Due to its conical shape, spear 26 can be retracted into spear receiving portion 24 at various angles relative to spear receiving portion 24 and be guided along inner arcuate surface 46 so as to be securely registered within spear receiving portion 24. In particular, spear 26 includes an outer arcuate surface 58 defining a conical tip 60, an intermediate tapered surface 62, a shoulder 64 and a cylindrical end 66.

Outer arcuate surface 58, and in particular conical tip 60, is shaped to enter into open end 44 of spear receiving portion 24 and guide spear 26 along arcuate surface 46 until tapered surface 62 registers with tapered portion 50 of inner arcuate surface 46. An outer surface of conical tip 60, relative to a central axis 67 of the spear 26, includes a greater slope than a slope of intermediate tapered surface 62 relative to the central axis 67. Shoulder 64, once spear is inserted into spear receiving portion 24, contacts recessed bevel 48 of inner arcuate surface 46 such that, when shoulder 64 and bevel 48 are in contact, relative movement between spear receiving portion 24 and spear 26 is limited. Moreover, when spear 26 is positioned within spear receiving portion 24, spear 26 and spear receiving portion 24 are generally coaxial. Cylindrical end 66 is shaped so as to be grasped by a user such that spear 26 can be brought toward an object for attachment thereto. In one embodiment, as viewed along a sectional line perpendicular to central axis 67, arcuate surface 58, and in particular conical tip 60, intermediate surface 62 and cylindrical end 66, is generally circular in shape.

Spear 26 further includes a pair of pin receiving portions 68 configured to receive pins 54 such that the pins 54 can be inserted into spear receiving portion 24 and secure spear 26 within the spear receiving portion 24. In one embodiment, pin receiving portions 68 are hemispherically shaped and positioned on opposite sides of spear 26. Moreover, spear 26 can be rotated within spear receiving portion 24 so as to align pin receiving portions 68 with apertures 52. Locking pins 54 are then inserted into apertures 52 and pin receiving portions 68 so as to lock spear 26 within spear receiving portion 24. In addition, an internal bore 70 is provided within spear 26, including an enlarged diameter portion 72, configured to accommodate cable 18. The cable 18 passes through bore 70 and can be swaged to spear 26 at the enlarged diameter portion 72.

Hitch plate 28 is attached to spear 26. In one embodiment, hitch plate 28 is welded to spear 26 and thus spear 26 and hitch plate 28 are fixed together for attachment to an object. To this end, hitch plate 28 includes an aperture 74 for connection to the object. For example, the object may include a pin that can be inserted into the aperture 74 for securing the object to the hitch plate 28. In other embodiments, hitch plate 28 can include other attachment mechanisms such as hooks, clips, etc. Hitch plate 28 is shown as attached to a bottom of spear 26. However, spear 26 can be rotated 180° such that hitch plate 28 is positioned on top of spear 26 in order to accommodate objects of different heights.

Accessory mounting portion 30 is a generally flat, rectangular plate mounted to attachment bar 20, using fastener receiving portions 38. Once mounted to the attachment bar 20, the accessory mounting portion 30 extends to one side of attachment bar 20. Mounting portion 30 also includes a set of fastener receiving portions 76 configured to receive fasteners that mount an accessory thereto.

As shown in FIG. 5, cable 18 includes a first end 82 and a second end 84. First end 82 is coupled to winch 12 and second end 84 is coupled to spear 26. In particular, second end 84 can be swaged with enlarged diameter portion 72, thus fixing second end 84 with spear 26. During use, winch 12 can be operated to wind cable 18 and/or retract cable 18, causing movement of spear 26 relative to spear receiving portion 24. As winch 12 is operated, spear 26 can be positioned at any angle relative to spear receiving portion 24, due to cooperation of inner arcuate surface 46 with outer arcuate surface 58. In particular, conical tip 60 is shaped to easily enter open end 44 as cable 18 is retracted into winch 12. As cable 18 is retracted, conical tip 60 slides along interior bevel 48 and towards open end 42 of spear receiving portion 24. As cable 18 is further retracted, intermediate tapered surface 62 seats within tapered portion 50. Thus, spear 26 can be attached to an object that is positioned to one side or another relative to spear receiving portion 24. As such, a user need not adjust a position of the object (e.g., such that spear 26 and spear receiving portion 24 are aligned) for spear 26 to register within spear receiving portion 24.

It is to be understood that the features of the various exemplary embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A winch assembly for use with a vehicle, comprising:
an attachment bar configured to be coupled to the vehicle;
a spear receiving portion coupled to the attachment bar and having an inner arcuate surface, the spear receiving portion further defining a first open end and a second open end opposite the first open end;
a spear having an outer arcuate surface configured to pass through the second open end of the spear receiving portion and seat within the spear receiving portion;
a winch coupled to the attachment bar; and
a cable coupled to the spear and the winch and configured to pass through the first open end of the spear receiving portion.

2. The winch assembly of claim 1, wherein the spear receiving portion is offset from the attachment bar.

3. The winch assembly of claim 1, further comprising a handle coupled to the attachment bar.

4. The winch assembly of claim 1, further comprising a hitch plate coupled to the spear, the hitch plate configured to be coupled to an object.

5. The winch assembly of claim 1, wherein the winch is a powered winch.

6. The winch assembly of claim 1, wherein the outer arcuate surface includes a conical tip and an intermediate tapered surface, the conical tip having a greater slope about a central axis of the spear than the intermediate tapered surface.

7. The winch assembly of claim 1, wherein the spear further includes a set of pin receiving portions and the spear receiving portion includes a set of apertures, the set of pin receiving portions configured to be aligned with the set of apertures so as to receive locking pins to lock the spear within the spear receiving portion.

8. A hitch assembly for use with a winch maintaining cable, comprising:
an attachment bar configured to support the winch;
a spear receiving portion coupled to the attachment bar and having an inner arcuate surface, the spear receiving portion further defining a first open end and a second open end; and
a spear having an outer arcuate surface configured to pass through the second open end of the spear receiving portion and seat within the inner arcuate surface of the spear receiving portion.

9. The hitch assembly of claim 8, wherein the spear receiving portion is offset from the attachment bar.

10. The hitch assembly of claim 8, further comprising a handle coupled to the attachment bar.

11. The hitch assembly of claim 8, further comprising a hitch plate coupled to the spear, the hitch plate configured to be coupled to an object.

12. The hitch assembly of claim 8, wherein the outer arcuate surface includes a conical tip and an intermediate tapered surface, the conical tip having a greater slope about a central axis of the spear than the intermediate tapered surface.

13. The hitch assembly of claim 8, wherein the spear further includes a set of pin receiving portions and the spear receiving portion includes a set of apertures, the set of pin receiving portions configured to be aligned with the set of apertures so as to receive locking pins to lock the spear within the spear receiving portion.

14. A method of operating a winch assembly, comprising:
providing a hitch assembly, comprising:
an attachment bar;
a spear receiving portion coupled to the attachment bar and having an inner arcuate surface, the spear receiving portion further defining a first open end and a second open end; and
a spear having an outer arcuate surface configured to pass through the second open end of the spear receiving portion and seat within the inner arcuate surface of the spear receiving portion;
coupling a winch to the attachment bar;
coupling a cable to the winch and the spear; and
retracting the cable so that the spear seats within the spear receiving portion.

15. The method of claim 14, wherein the spear receiving portion is offset from the attachment bar.

16. The method of claim 14, further comprising providing a handle coupled to the attachment bar.

17. The method of claim 14, further comprising a hitch plate coupled to the spear, the hitch plate configured to be coupled to an object.

18. The method of claim 14, wherein the winch is a powered winch.

19. The method of claim 14, wherein the outer arcuate surface includes a conical tip and an intermediate tapered surface, the conical tip having a greater slope about a central axis of the spear than the intermediate tapered surface.

20. The method of claim 14, wherein the spear further includes a set of pin receiving portions and the spear receiving portion includes a set of apertures, the set of pin receiving portions configured to be aligned with the set of apertures so as to receive locking pins to lock the spear within the spear receiving portion.
